(19) United States
(12) Patent Application Publication
(10) Pub. No.: US 2010/0189331 A1
(43) Pub. Date: Jul. 29, 2010

(54) APPARATUS FOR DETERMINING A HIGH DENSITY REGION IN AN IMAGE

(75) Inventors: Peter Forthmann, Sandesneben (DE); Thomas Koehler, Norderstedt (DE); Holger Schmitt, Hamburg (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., Eindhoven (NL)

(21) Appl. No.: 12/664,662

(22) PCT Filed: Jun. 11, 2008
(86) PCT No.: PCT/IB2008/052308

§ 371 Date: Dec. 15, 2009

(30) Foreign Application Priority Data
Jun. 15, 2007 (EP) 07110372.5

(51) Int. Cl. G06K 9/00

(52) U.S. Cl. 382/131

(57) ABSTRACT

The invention relates to an apparatus for determining a high density region in an image, wherein the apparatus comprises a provision unit (1, 2, 6, 7, 8) for providing projection data for reconstructing the image. The apparatus comprises further a high density shadow determination unit (12) for determining a high density shadow in the projection data and a backprojection unit (13) for backprojecting the determined high density shadow resulting in a high density image showing the high density region. The inventions relates further to a corresponding method and computer program for determining a high density region in an image.

### FIELD OF THE INVENTION

The invention relates to an apparatus, a method, and a computer program for determining a high density region in an image. The invention relates further to an imaging system, an imaging method and a computer program for imaging a region of interest comprising high density regions.

### BACKGROUND OF THE INVENTION

In computed tomography images high density regions, like metal regions, are determined by thresholding. The determined high density regions are, for example, used for the correction of high density artifacts in the computed tomography images. But the segmentation of high density regions in the computed tomography image suffers from the high density artifacts, which are already present in the computed tomography image. This leads to a reduced quality of the segmentation of high density regions in the computed tomography image and, therefore, if the segmentation is used for a correction of the computed tomography image for high density artifacts, the corrected computed tomography image will still show a lot of artifacts caused by the high density region within the computed tomography image.

### SUMMARY OF THE INVENTION

It is an object of the present invention to provide an apparatus, a method and a computer program for determining a high density region in an image, wherein the accuracy of the determination of a high density region in an image is improved.

In a first aspect of the present invention an apparatus for determining a high density region in an image is presented, wherein the apparatus comprises

a provision unit for providing projection data for reconstructing the image,

a high density shadow determination unit for determining a high density shadow in the projection data,

a backprojection unit for backprojecting the determined high density shadow resulting in a high density image showing the high density region.

The invention is based on the idea that, since the high density shadow is backprojected resulting in a high density image, the high density region can be identified in the high density image, without the need of a segmentation of a high density region in an image having already high density artifacts. Thus, the high density artifacts in the uncorrected image do not disturb the determination of the high density region which improves the accuracy of the determination of the high density region.

A high density region can be a single region, but it can also comprise several regions, which are connected or unconnected. Also the high density shadow can be a single shadow or can comprise several shadow regions, which are connected or unconnected.

A high density region is a region within the region of interest which is occupied by one or several high density elements like metal elements. A high density element is an element having a density above a predetermined density value. This predetermined density value is preferentially predetermined such that high density elements, which generally produce high density artifacts in the reconstructed image, have a density larger than the predetermined density value, for example, in a computed tomography system this predetermined density value is preferentially 2500 Hounsfield units, wherein metal elements have a larger density.

It is preferred that the high density shadow determination unit is adapted for segmenting the high density shadow in the projection data and that the apparatus further comprises a high density region determination unit for determining the high density region in the high density image, wherein the high density region determination unit is adapted for determining the number of projections from which an image element of the high density image has received projection data of the segmented high density shadow and determining image elements of the high density region depending on the number of projections from which an image element of the high density image has received projection data of the segmented high density shadow. This further improves the accuracy of the determination of the high density region.

In a preferred embodiment, the high density region determination unit is adapted for determining image elements of the high density region by determining the image elements, which have received projection data of the segmented high density shadow from a number of projections, which equals a predetermined number. Preferentially, this predetermined number is equal to the number of projections through the respective image element. The predetermined number can be predetermined by, for example, a user in order to adjust the accuracy level of the determination of the high density region.

It is further preferred that the high density shadow determination unit determines the high density shadow by thresholding. By thresholding the high density shadow can be determined by the projection data with low computational costs.

It is further preferred that the apparatus further comprises a correction unit for correcting high density artifacts in the image using the determined high density region in the high density image. Since the high density region has been determined with high accuracy, the correction of high density artifacts in the image can be performed with high quality, i.e. the reduction of high density artifacts is improved compared to known high density artifact corrections, which use known determinations of high density regions in an image.

In a further aspect of the invention, an imaging system for imaging a region of interest comprising high density regions is presented, wherein the imaging system comprises:

a projection data generation unit for generating projection data for reconstructing the image,

a high density shadow determination unit for determining a high density shadow in the projection data,

a backprojection unit for backprojecting the determined high density shadow resulting in a high density image showing the high density region,

a reconstruction and correction unit for reconstructing an image of the region of interest from the projection data, wherein the reconstruction and correction unit is adapted for correcting high density artifacts in the reconstructed image of the region of interest by using the determined high density region in the high density image.

In a further aspect of the present invention, a method for determining high density shadows in projection data is presented, wherein the method comprises the following steps

providing projection data for reconstructing the image,

determining a high density shadow in the projection data,

backprojecting the determined high density shadow resulting in a high density image showing the high density region.

In a further aspect of the present invention, an imaging method for imaging a region of interest comprising high density regions is presented, wherein the imaging method comprises the following steps:

generating projection data for reconstructing the image,

determining a high density shadow in the projection data,

backprojecting the determined high density shadow resulting in a high density image showing the high density region,

reconstructing an image of the region of interest from the projection data, wherein high density artifacts in the reconstructed image of the region of interest are corrected using the determined high density region in the high density image.

In a further aspect of the invention, a computer program for determining a high density region in an image is presented, wherein the computer program comprises program code means for causing an apparatus as defined in claim 1 to carry out following steps, when the computer program is run on a computer controlling the apparatus:

providing projection data for reconstructing the image,

determining a high density shadow in the projection data,

backprojecting the determined high density shadow resulting in a high density image showing the high density region.

In a further aspect of the invention a computer program for imaging a region of interest comprising high density regions is presented, wherein the computer program comprises program code means for causing an apparatus as defined in claim 6 to carry out following steps, when the computer program is run on a computer controlling the apparatus:

generating projection data for reconstructing the image,

determining a high density shadow in the projection data,

backprojecting the determined high density shadow resulting in a high density image showing the high density region,

reconstructing an image of the region of interest from the projection data, wherein high density artifacts in the reconstructed image of the region of interest are corrected using the determined high density region in the high density image.

It shall be understood that the apparatus of claim 1, the imaging system of claim 6, the method of claim 7, the imaging method of claim 8, the computer program of claim 9 and the computer program of claim 10 have similar and/or identical preferred embodiments as defined in the dependent claims. It shall be understood that preferred embodiments of the invention can also be any combination of the dependent claims.

### BRIEF DESCRIPTION OF THE DRAWINGS

These and other aspects of the invention will be apparent from and elucidated with reference to the embodiments described hereinafter. In the following drawings

FIG. 1 shows schematically an embodiment of an imaging system for imaging a region of interest comprising high density regions in accordance with the invention,

FIG. 2 shows a flowchart illustrating an embodiment of an imaging method for imaging a region of interest comprising high density regions in accordance with the invention,

FIG. 3 shows schematically an embodiment of an apparatus for determining a high density region in an image in accordance with the invention, and

FIG. 4 shows a flowchart illustrating an embodiment of a method for determining a high density region in an image.

### DETAILED DESCRIPTION OF EMBODIMENTS

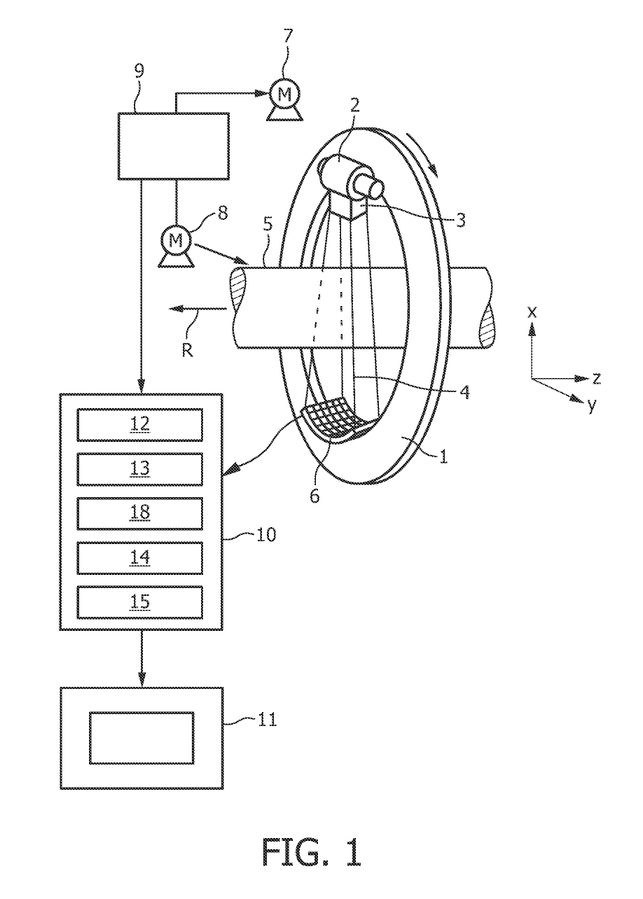

FIG. 1 shows schematically a system for imaging a region of interest comprising high density regions, which is, in this embodiment, a computed tomography system. The computed tomography system includes a gantry 1, which is capable of rotating about an axis of rotation R which extends parallel to the z direction. A radiation source 2, for example and X-ray source, is mounted on the gantry 1. The radiation source 2 is provided with a collimator device 3 which forms a conical radiation beam 4 from the radiation emitted by the radiation source 2. In other embodiments, the collimator device 3 can be adapted for forming a radiation beam having another shape, for example, having a fan shape. The radiation traverses a region of interest, for example, a region of interest of a patient in a cylindrical examination zone 5. After having traversed the examination zone 5, the radiation beam 4 is incident on a detection unit 6, in this embodiment a two-dimensional detector, which is mounted on the gantry 1. In another embodiment, the detection unit can be a one-dimensional detector.

The gantry 1 is driven at a preferably constant but adjustable angular speed by a motor 7. A further motor 8 is provided for displacing the object, for example, a patient who is arranged on a patient table in the examination zone 5, parallel to the direction of the axis of rotation R or the z axis. These motors 7, 8 are controlled by a control unit 9, for instance, such that the radiation source 2 and the examination zone 5 move relative to each other along a helical trajectory. The motors 7, 8 can also be controlled by the control unit 9 such that the region of interest, i.e. an object or a part of an object located in the region of interest, or the examination zone 5 are not moved and that the radiation source 2 is rotated, i.e. that the radiation source 2 travels along a circular trajectory relative to the object. The radiation source 2, the detection unit 6, the gantry 1, preferentially the collimator device 3, and the motors 7, 8 form a projection data generation unit for generating projection data for reconstructing an image of the region of interest or a provision unit for providing projection data for reconstructing an image of the region of interest.

The projection data acquired by the detection unit 6 are provided to an imaging and correction device 10 for determining a high density region in an image and for reconstructing an image of the region of interest in which the high density artifacts are corrected using the determined high density region. The corrected image can finally be displayed on a display unit 11.

The imaging and correction device 10 comprises a high density shadow determination unit 12 for determining a high density shadow in the projection data. A backprojection unit 13 for backprojecting the determined high density shadow resulting in a high density image showing the high density region, a reconstruction unit 14 for reconstructing an image of the region of interest from the projection data and a correction unit 15 for correcting high density artifacts in the reconstructed image of the region of interest using the determined high density region in the high density image.

The reconstruction unit 14 and the correction unit 15 form a reconstruction and correction unit. The reconstruction and correction unit 14, 15 reconstructs, in this embodiment, an image of the region of interest from the projection data and than corrects high density artifacts within the reconstructed image of the region of interest using the determined high density region in the high density image. In another embodiment, a reconstruction and correction unit can be provided, which corrects for high density artifacts during the reconstruction of an image of the region of interest from the projection data using the determined high density region in the high density image.

The imaging and correction device 10 further comprises a high density region determination unit 18 for determining the high density region in the high density image.

Also the imaging and correction device 10 is preferentially controlled by the control unit 9.

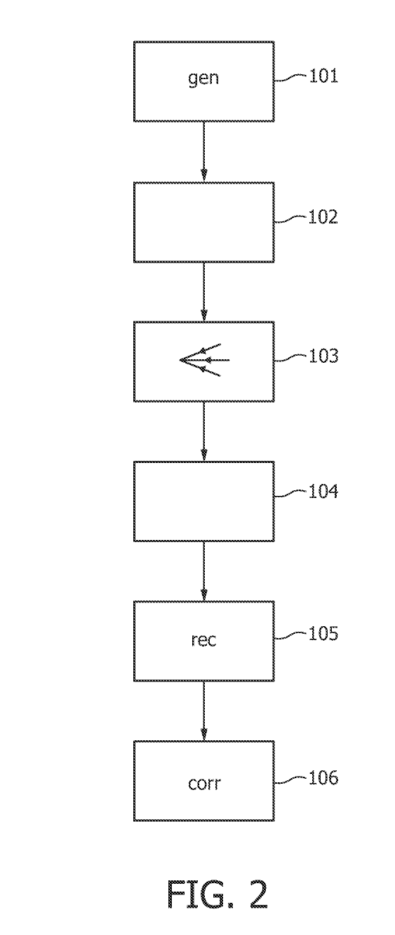

In the following an embodiment of an imaging method for imaging a region of interest comprising high density regions in accordance with the invention will be described in more detail with reference to a flowchart shown in FIG. 2.

In step 101 projection data are generated for reconstructing an image of the region of interest. The radiation source 2 rotates around the axis of rotation R or the z direction, and the region of interest is not moved, i.e. the radiation source 2 travels along a circular trajectory around the region of interest. In another embodiment, the radiation source 2 can move along another trajectory, for example, along a helical trajectory relative to the region of interest. The radiation source 2 emits radiation traversing the region of interest in which a high density region, for example a region comprising metal, is present. In the region of interest is, for example, an object like a patient present. The radiation, which has passed the region of interest, is detected by the detection unit 6, which generates projection data, which are transmitted to the imaging and correction device 10.

In step 102, the high density shadow determination unit 2 determines the high density shadow in the projection data. A high density shadow in the projection data is caused by the high absorption of the high density elements in the high density region in the region of interest. A high density region is a region within the region of interest which is occupied by one or several high density elements like metal elements. A high density element is an element having a density above a predetermined density value. This predetermined density value is preferentially predetermined such that high density elements, which generally produce high density artifacts in the reconstructed image, have a density larger than the predetermined density value, for example, in a computed tomography system the density value is preferentially, wherein metal elements have a larger density.

The high density shadow in the projection data is preferentially determined by thresholding. An appropriate threshold value can, for example, be determined by calibration, wherein a known distribution of high density elements within the region of interest and, therefore, a known distribution of high density shadows in the projection data are used.

Preferentially, to the projection data located within a determined high density shadow, the same value is assigned, for example, 1. This preferred assignment can be defined by following equation:

$${p}^{′} ( u , v , λ ) = \{ \begin{matrix}1 , & p ( u , v , λ ) > t \\ 0 , & else .\end{matrix} \qquad ( 1 )$$

In equation (1), p′(u v,λ) denotes the segmented projection, wherein the high density shadows are marked by a 1, u, v denote the position on the two-dimensional detection unit 6, λ denotes the angular position of the radiation source 2 on the circular or helical trajectory, p(u,v,λ) denote the projection data, which have been generated in step 101, and t denotes a threshold value. Thus, p′(u,v,λ) indicates one or several high density shadows in the projection data p(u,v,λ).

In step 103, the determined high density shadow or the determined high density shadows p′(u,v,λ) are unfiltered backprojected to yield a high density image I(x,y,z). During backprojection of a projection data value within a high density shadow, to each image element, which is traversed by the corresponding backprojected ray, a 1 is added. Thus, an image element, which corresponds to a high density element within the region of interest, has a value, which is equal to the number N of projections, which have traversed this image element of the high density element during generation of the projection data in step 101. Thus, in step 104, the high density region determination unit 18 preferentially determines the high density region within the region of interest or within the high density image in accordance with the following equation:

$${I}^{′} ( x , y , z ) = \{ \begin{matrix}1 , & I ( x , y , z ) = N \\ 0 , & else .\end{matrix} \qquad ( 2 )$$

In equation (2), I′(x,y,z) denotes the determined one or several high density regions, and the high density image is denoted by I(x,y,z). According to equation (2), to each image element of the high density image, which have a value of N, a 1 is assigned, and to the other image elements of the high density elements a 0 is assigned. Thus, one or several high density regions have been determined and segmented in the high density image.

In other embodiments, image elements having a value larger than a predetermined number of projections, which contributed to the respective image element, can be assigned to and segmented as an image element of a high density region. This allows adjusting the accuracy of the determination of one or several high density regions within the high density image.

In step 105, the reconstruction unit 14 reconstructs an image of the region of interest from the projection data, for example, by using a filtered backprojection, and, in step 106, the correction unit 15 corrects high density artifacts in the reconstructed image of the regionof interest using the one or several high density regions determined in step 104.

The correction in step 106 can, for example, be performed by, for example, (1) filling the high density regions determined in step 104 with data interpolated from the material surrounding those regions, (2) forward projecting the resulting image, (3) replacing the projection data of rays that have passed through the high density regions in the original projection data set by the ones from the forward projection of the image with the high density replacements, and (4) doing another reconstruction from the altered data set. This is, for example, disclosed in “Metal artifact reduction in CT using tissue-class modeling and adaptive prefiltering”, M. Bal and L. Spies, Med. Phys. 33 (8), August 2006, which is herewith incorporated by reference.

In another embodiment, step 106 can be omitted, and the one or several high density regions can already be used during the reconstruction step 105 in order to reconstruct an image of the region of interest having no or a reduced amount of high density artifacts. This can, for example, be performed by (1) identifying high density shadows in the projection data by forward projecting the high density regions determined in step 104, (2) replacing projection data within the determined high density shadows with data interpolated from projection data regions surrounding the high density shadows, thereby generating synthesized projection data, and (3) backprojecting the synthesized projection data.

If one or several high density regions are already used during the reconstruction step 105 in order to reconstruct an image of the region of interest having nor or a reduced amount of high density artifacts, a corresponding reconstruction and correction unit is provided, which performs this correction during the reconstruction of the image of the region of interest, i.e. preferentially before a backprojection the projection data are processed using the determined high density regions, preferentially after a forward projection of the determined high density regions as described above.

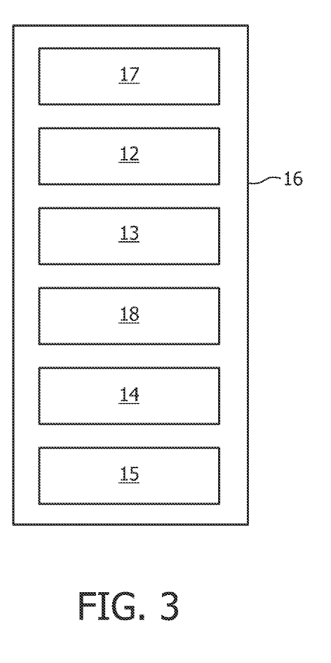

FIG. 3 shows schematically an apparatus 16 for determining a high density region in an image. Corresponding units in FIG. 1 and FIG. 3 have the same reference numerals.

The apparatus 16 comprises a provision unit 17 for providing projection data for reconstructing the image, a high density shadow determination unit 12 for determining a high density shadow in the projection data and a backprojection unit 13 for backprojecting the determined high density shadow resulting in a high density image showing the high density region. The apparatus 16 comprises further a high density region determination unit 14 for determining the high density region in the high density image and a correction unit 15 for correcting high density artifacts in the image using the determined high density region in the high density image.

The provision unit 17 is, in this embodiment, a storage unit, in which projection data for reconstructing the image are stored. This projection data can be real data, which have been measured, for example, by a computed tomography system, or simulated data. The provision unit 17 can also be a combination of a system of a radiation source and a detection unit, which are moveable with respect to a region of interest, in order to generate projection data from different directions. The high density shadow determination unit 12, the backprojection unit 13, the reconstruction unit 14, and the correction unit 15 are similar to the corresponding units described above with reference to FIG. 1. The apparatus 16 also comprises preferentially a high density region determination unit 18, which is similar to the high density region determination unit 18 described above with reference to FIG. 1.

Instead of a reconstruction unit 14 and a correction unit 15, a single correction unit can be used, which reconstructs an image of the region of interest, wherein the correction of high density artifacts using the determined high density region is performed during the reconstruction.

The high density region determination unit 18, the reconstruction unit 14 and the correction unit 15 of the apparatus 16 for determining a high density region in an image are optional units. Thus, in other embodiments, the apparatus can only comprise a provision unit for providing projection data for reconstructing the image, a high density shadow determination unit for determining a high density shadow in the projection data and a backprojection unit for backprojecting the determined high density shadow resulting in a high density image showing the high density region. These units allow determining high density regions in an image of a region of interest.

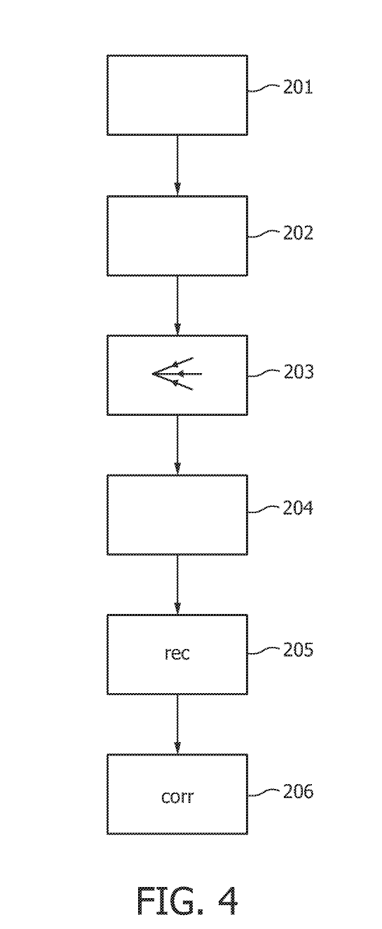

In the following, an embodiment of a method for determining a high density region in an image will be described with reference to a flowchart shown in FIG. 4.

In step 201 projection data are provided for reconstructing the image by the provision unit 17. In step 202, the high density shadow determination unit 12 determines a high density shadow in the projection data, and in step 203 the determined high density shadow is backprojected by the backprojection unit 13 resulting in a high density image showing the high density region. In step 204, the high density region determination unit 18 determines the high density region in the high density image, in step 205 the reconstruction unit 14 reconstructs the image of the region of interest, and in step 206 the correction unit corrects the reconstructed image for high density artifacts using the determined high density region in the high density image.

Steps 202 to 206 are similar to steps 102 to 106 of FIG. 2. For a more detailed explanation of these steps reference is therefore made to the above description of FIG. 2.

Although the invention has mainly been described as using projection data of a computed tomography system, in particular of an X-ray computed tomography system, the invention is not limited to this modality. Any projection data, which are generated by projecting radiation through a region of interest by a measurement or by simulations, can be used in accordance with the invention. For example, projection data of a nuclear imaging system can be used, i.e. the provision unit of the apparatus for determining a high density region in an image can provide projection data of an nuclear imaging system or another system, which provides projection data.

Although different units are described which perform different functions, only a single unit or another number of units can be used, which are adapted for performing the above mentioned functions, for example, the backprojection unit for backprojecting the determined high density shadow and the reconstruction unit for reconstructing an image of the region of interest can be implemented in a single unit, which performs the backprojection of the determined high density shadow and the reconstruction of the image using the provided projection data. The units can be implemented as one or several computer programs and/or as dedicated hardware.

Although in the above described embodiments special correction methods for correcting high density artifacts in a reconstructed image of a region of interest using the determined high density shadow or the determined high density shadows have been described, the invention is not limited to these certain correction methods. Every correction method which uses determined high density regions or determined high density shadows, which can be determined by a forward projection of the determined high density regions, can be used in accordance with the invention.

Other variations to the disclosed embodiments can be understood and effected by those skilled in the art and practicing the claimed invention from the study of the drawings, the disclosure and the appended claims.

While the invention has been illustrated and described in detail in the drawings and in the foregoing description, such illustration and description are to be considered illustrative or exemplary and not restrictive. The invention is not limited to the disclosed embodiments.

In the claims the word “comprising” does not exclude other elements or steps and the indefinite article “a” or “an” does not exclude a plurality.

A computer program may be stored/distributed on a suitable medium, such as an optical storage medium or a solid-state medium supplied together with or as part of other hardware, but may also be distributed in other forms, such as via the internet or other wired or wireless telecommunication systems.

Any reference signs in the claims should not be construed as limiting the scope of the invention.

1. An apparatus for determining a high density region in an image, wherein the apparatus comprises
a provision unit (1, 2, 6, 7, 8; 17) for providing projection data for reconstructing the image,
a high density shadow determination unit (12) for determining a high density shadow in the projection data,
a backprojection unit (13) for backprojecting the determined high density shadow resulting in a high density image showing the high density region.

2. The apparatus as claimed in claim 1,
wherein the high density shadow determination unit (12) is adapted for segmenting the high density shadow in the projection data and
wherein the apparatus further comprises a high density region determination unit (18) for determining the high density region in the high density image,
wherein the high density region determination unit (18) is adapted for
determining the number of projections from which an image element of the high density image has received projection data of the segmented high density shadow and
determining image elements of the high density region depending on the number of projections from which an image element of the high density image has received projection data of the segmented high density shadow.

3. The apparatus as claimed in claim 2,
wherein the high density region determination unit (12) is adapted for determining image elements of the high density region by determining the image elements, which have received projection data of the segmented high density shadow from a number of projections, which equals a predetermined number.

4. The apparatus as claimed in claim 1, wherein the high density shadow determination unit (12) determines the high density shadow by thresholding.

5. The apparatus as claimed in claim 1, wherein the apparatus further comprises a correction unit (15) for correcting high density artifacts in the image using the determined high density region in the high density image.

6. An imaging system for imaging a region of interest comprising high density regions, wherein the imaging system comprises:
a projection data generation unit (1, 2, 6, 7, 8) for generating projection data for reconstructing the image,
a high density shadow determination unit (12) for determining a high density shadow in the projection data,
a backprojection unit (13) for backprojecting the determined high density shadow resulting in a high density image showing the high density region,
a reconstruction and correction unit (14, 15) for reconstructing an image of the region of interest from the projection data, wherein the reconstruction and correction unit (14, 15) is adapted for correcting high density artifacts in the reconstructed image of the region of interest by using the determined high density region in the high density image.

7. A method for determining a high density region in an image, wherein the method comprises following steps
providing projection data for reconstructing the image,
determining a high density shadow in the projection data,
backprojecting the determined high density shadow resulting in a high density image showing the high density region.

8. An imaging method for imaging a region of interest comprising high density regions, wherein the imaging method comprises following steps:
generating projection data for reconstructing the image,
determining a high density shadow in the projection data,
backprojecting the determined high density shadow resulting in a high density image showing the high density region,
reconstructing an image of the region of interest from the projection data, wherein
high density artifacts in the reconstructed image of the region of interest are corrected using the determined high density region in the high density image.

9. A computer program for determining a high density region in an image, comprising program code means for causing an apparatus as defined in claim 1 to carry out following steps, when the computer program is run on a computer controlling the apparatus:
providing projection data for reconstructing the image,
determining a high density shadow in the projection data,
backprojecting the determined high density shadow resulting in a high density image showing the high density region.

10. A computer program for imaging a region of interest comprising high density regions, comprising program code means for causing an apparatus as defined in claim 6 to carry out following steps, when the computer program is run on a computer controlling the apparatus:
generating projection data for reconstructing the image,
determining a high density shadow in the projection data,
backprojecting the determined high density shadow resulting in a high density image showing the high density region,
reconstructing an image of the region of interest from the projection data, wherein
high density artifacts in the reconstructed image of the region of interest are corrected using the determined high density region in the high density image.
